(19) United States
(12) Patent Application Publication
(10) Pub. No.: US 2008/0279394 A1
(43) Pub. Date: Nov. 13, 2008

(54) Noise suppressing apparatus and method for noise suppression

(75) Inventors: Takehiko Isaka, Hachioji-shi (JP); Kimio Miseki, Ome-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/012,976

(22) Filed: Feb. 6, 2008

(30) Foreign Application Priority Data
May 9, 2007 (JP) 2007-124766

(51) Int. Cl. H04B 15/00

(52) U.S. Cl. 381/94.7

(57) ABSTRACT

A common component extraction unit extracts a component Mi(n) included commonly in the plural input channels. A non-common component extraction unit extracts a component Si(n) not common to the plural input channels. A common component noise suppression unit obtains signal Mo(n) by executing a noise suppression process for the component Mi(n). A non-common component processing unit obtains signal So(n) by executing attenuation or emphasis for the component Si(n). A plural-channel generation unit removes noise of the common component from signals In(n, k) of the plural input channels, by using the signals Mo(n) and So(n) such that the non-common component is attenuated or emphasized.

### CROSS-REFERENCE TO RELATED APPLICATIONS

This application is based upon and claims the benefit of priority from prior Japanese Patent Application No. 2007-124766, filed May 9, 2007, the entire contents of which are incorporated herein by reference.

### BACKGROUND OF THE INVENTION

1. Field of the Invention

The present invention relates to a noise suppressing apparatus suppressing noise in a speech signal having a plurality of channels.

2. Description of the Related Art

In a conventional noise suppressing method for a stereo signal, for example, noise is suppressed by superposing noise of a reverse phase on each of L channel and R channel (cf., for example, Jpn. Pat. Appln. KOKAI Publication No. 2-205120). In this method, noise components (ea, eb) included commonly in both the channels L and R can be suppressed but suppression of noise in the stereo components is difficult. In addition, since a suppressed sound image is not considered, the sound image becomes unnatural.

The conventional noise suppressing apparatus has a problem that a noise component included in a stereo signal cannot be suppressed while maintaining a natural sound image.

### BRIEF SUMMARY OF THE INVENTION

The present invention has been accomplished to solve the above-described problems. The object of the present invention is to provide a noise suppressing apparatus and method for noise suppression capable of suppressing a noise component included in a stereo signal while maintaining a natural sound image.

To achieve this object, an aspect of the present invention is a noise suppressing apparatus suppressing noise components included in input signals of a plurality of channels. The apparatus comprises: a common component extraction unit which extracts a component common to a first channel signal and a second channel signal; a common component noise suppression unit which suppresses noise in the common component extracted by the common component extraction unit; a non-common component extraction unit which extracts a component not common to the first channel signal and the second channel signal; a non-common component processing unit which executes level adjustment of the non-common component extracted by the non-common component extraction unit; and a plural-channel generation unit which generate the first channel signal and the second channel signal having the noise components suppressed, from an output of the common component noise suppression unit and an output of the non-common component processing unit, respectively.

As described above, according to the present invention, a component common to the first channel signal and the second channel signal is obtained to execute noise suppression, and a component not common to the first channel signal and the second channel signal is obtained to execute the level adjustment. On the basis of the noise suppression and the level adjustment, the first channel signal and the second channel signal in which the noise component is suppressed are generated.

Therefore, the present invention can provide a noise suppressing apparatus and method for noise suppression capable of suppressing the noise component included in the stereo signal while maintaining a natural sound image.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of a noise suppressing apparatus according to a first embodiment of the present invention;

FIG. 2 is a block diagram showing a configuration of the noise suppressing apparatus shown in FIG. 1 having two systems for input signals;

FIG. 3 is a block diagram showing a configuration of a noise suppressing apparatus according to a second embodiment of the present invention;

FIG. 4 is a block diagram showing a configuration of the noise suppressing apparatus shown in FIG. 3 having two systems for input signals;

FIG. 5 is a block diagram showing a configuration of a noise suppressing apparatus according to a third embodiment of the present invention; and

FIG. 6 is a block diagram showing a configuration of the noise suppressing apparatus shown in FIG. 5 having two systems for input signals.

### DETAILED DESCRIPTION OF THE INVENTION

Embodiments of the present invention will be described below with reference to the accompanying drawings.

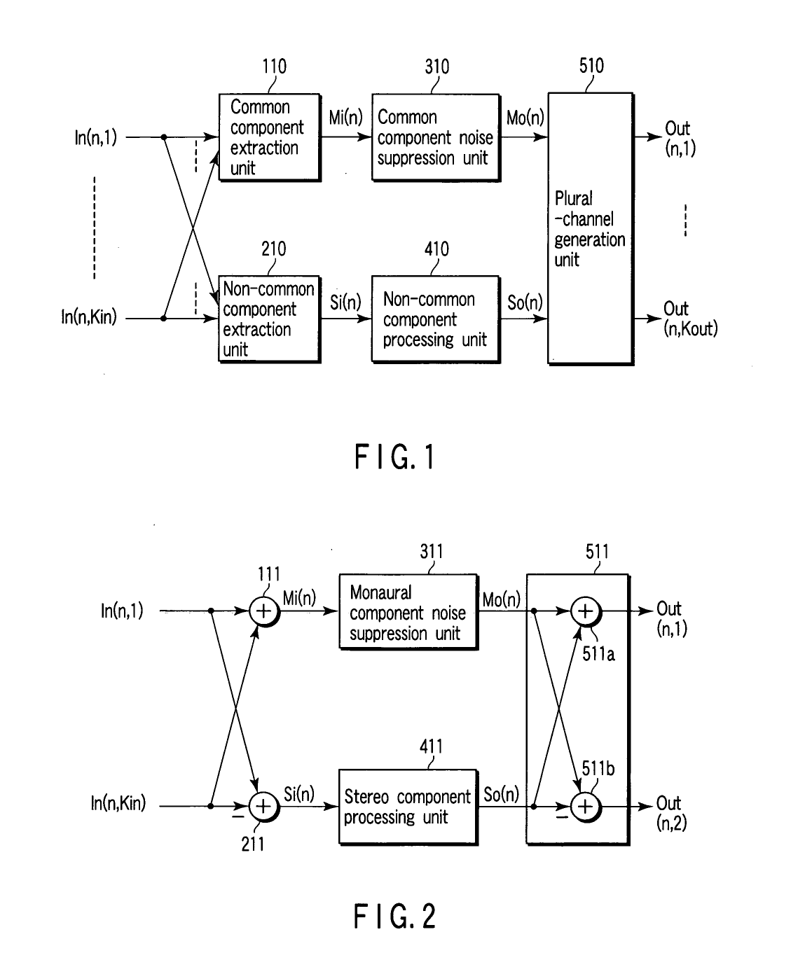

FIG. 1 shows a configuration of a noise suppressing apparatus according to a first embodiment of the present invention.

The noise suppressing apparatus comprises a common component extraction unit 110, a non-common component extraction unit 210, a common component noise suppression unit 310, a non-common component processing unit 410, and a plural-channel generation unit 510.

The common component extraction unit 110 inputs signals In(n, k) (k=1, . . . , Kin: Kin represents the total number of input channels and n represents the time) of a plurality of input channels and extracts a component Mi(n) included commonly in the plural input channels.

The non-common component extraction unit 210 inputs the signals In(n, k) of the plural input channels and extracts a component Si(n) not common to the plural input channels.

The common component noise suppression unit 310 obtains signal Mo(n) by executing a noise suppression process for the component Mi(n) extracted by the common component extraction unit 110, and then outputs the signal Mo(n).

The non-common component processing unit 410 obtains signal So(n) by executing a predetermined level adjustment process (for example, attenuation or emphasis) for the component Si(n) extracted by the non-common component extraction unit 210, and then outputs the signal So(n).

The plural-channel generation unit 510 removes noise of the common component from the signals In(n, k) of the plural input channels, by using the signal Mo(n) obtained by the common component noise suppression unit 310 and the signal So(n) obtained by the non-common component processing unit 410, and outputs each of output signals Out(n, k) (k=1, . . . , Kout: Kout represents the total number of output channels, and n represents the time) in which the non-common component is attenuated or emphasized.

Each of the total number of input channels Kin and the total number of output channels Kout may preferably be equal to or greater than 2. To simplify the following descriptions, the case of Kin and Kout being equal to 2, i.e. the stereo input and the stereo output is explained. In this case, for example, the noise suppressing apparatus shown in FIG. 1 may be constituted as shown in FIG. 2.

A common component extraction unit 111 inputs signals In(n, 1) and In(n, 2) of two input channels and extracts component Mi(n) included commonly in the two input channels. For example, the component is extracted by an operation represented by the following formula (1). In other words, by executing addition of the signals In(n, 1) and In(n, 2) of the two input channels, the signal whose component of the common phase becomes more remarkable is obtained. If necessary, a process of synchronizing the phase by shifting the time axes of the signals In(n, 1) and In(n, 2) may be added.

Mi(n)=In(n, 1)+In(n, 2) (1)

A non-common component extraction unit 211 inputs the signals In(n, 1) and In(n, 2) of two input channels and extracts component Si(n) not common to the two input channels. For example, the component is extracted by an operation represented by the following formula (2). In other words, by executing subtraction of the signals In(n, 1) and In(n, 2) of the two input channels, the signal whose component not common in phase becomes more remarkable is obtained. If necessary, a process of synchronizing the phase by shifting the time axes of the signals In(n, 1) and In(n, 2) may be added.

Si(n)=In(n, 1)−In(n, 2) (2)

A monaural component noise suppression unit 311 obtains signal Mo(n) by executing a noise suppression process for the component Mi(n) extracted by the common component extraction unit 111, and then output the signal Mo(n). As the method of noise suppressing process, what is called Spectral Subtraction (SS) is disclosed in a document, S. F. Boll, “Suppression of acoustic noise in speech using spectral subtraction”, IEEE Trans. ASSP, vol. 27, No. 2, pp. 113-120, February 1979 (page 114, Chapter 2, item C). Besides, what is called MMSE-STSA disclosed in Y. Ephraim et al., “Speech enhancement using a minimum mean-square error short-time spectral amplitude estimator” ASSP, vol. 32, No. 6, pp. 1109-1121, 1984 (page 1118, formula (53)), Wiener filter disclosed in J. S. Lim and A. V. Oppenheim, “Enhancement and Bandwidth Compression of Noisy Speech” Proc. Of the IEEE, vol. 67, pp. 1586-1604, December 1979, and the like are typical noise suppressing methods.

In these methods, the noise component in the input signal is suppressed by bringing the gain in band k close to 1 (i.e. suppression amount =0 dB) as the signal-to-noise ratio SNR(k) in each frequency band is greater, and bringing the gain in band k close to 0 or the positive lower limit value as the SNR(k) is smaller.

In the stereo component processing unit 411, a predetermined level adjustment process (for example, attenuation or emphasis) is executed for the component Si(n) extracted by the non-common component extraction unit 211, and signal So(n) is obtained and output. In the case of attenuation, an operation is executed in the following formula (3) using gain G.

So(n)=G*Si(n) (3)

where 0<G<1, for example, G is 0.5. In the case of emphasis, formula (3) is calculated where 1<G, for example, G_low is 2. In addition, to suppress the noise, G may be 1, i.e. the signal So(n) may be output without executing any process in the stereo component processing unit 411.

The plural-channel generation unit 511 comprises a channel generation unit 511a and a channel generation unit 511b. Each of the channel generation unit 511a and the channel generation unit 511b removes the noise of the common component from the signals In(n, 1) and In(n, 2) of the two input channels and outputs output signals Out(n, 1) and Out(n, 2) obtained by attenuating or emphasizing the non-common component, by using the signal Mo(n) obtained by the monaural component noise suppression unit 311 and the signal So(n) obtained by the stereo component processing unit 411. For example, the output signals are obtained by operations represented below in formula (4) and formula (5) and then output.

Out(n, 1)=Mo(n)+So(n) (4)

Out(n, 2)=Mo(n)−So(n) (5)

To make the amplitudes of the signals In(n, 1) and In(n, 2) of the two input channels match the amplitude of each of the output signals Out(n, 1) and Out(n, 2), Out_new(n, 1) and Out_new(n, 2) may be output instead of Out(n, 1) and Out(n, 2) by adding operations represented below in formula (6) and formula (7). K represents a coefficient for matching the amplitudes of the input signals and output signals. For example, K may be (1+G).

Out_new(n, 1)=K*Out(n, 1) (6)

Out_new(n, 2)=K*Out(n, 2) (7)

In the noise suppressing apparatus having the above-described configuration, noise of the sound in which the sound image is present in the central direction, of the signals of the two input channels, i.e. stereo signals, is suppressed and, for example, an effect of making voice of an announcer commentating in a live sport program or the like easily heard can be obtained. In addition, the stereo component can be attenuated or emphasized irrespective of the monaural component. For this reason, if the stereo component is subjected to gain adjustment such as adjusting the sound volume, the sound can be heard with a natural sound image.

Next, a noise suppressing apparatus according to a second embodiment of the present invention will be described.

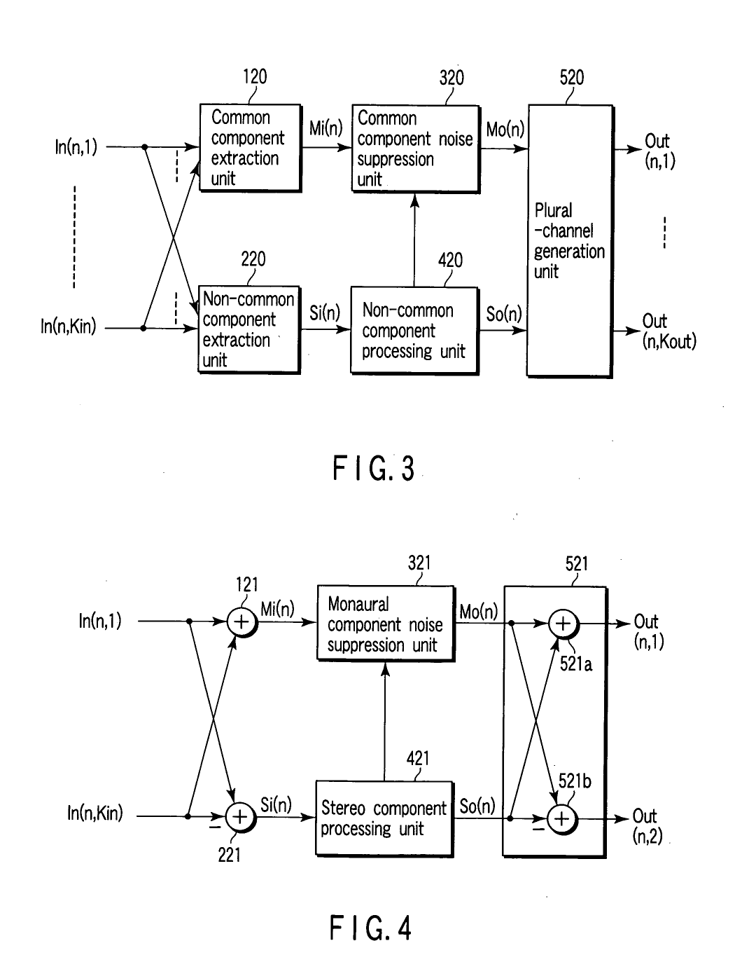

FIG. 3 shows a configuration of the noise suppressing apparatus according to the second embodiment.

The noise suppressing apparatus comprises a common component extraction unit 120, a non-common component extraction unit 220, a common component noise suppression unit 320, a non-common component processing unit 420, and a plural-channel generation unit 520.

The common component extraction unit 120 inputs signals In(n, k) (k=1, . . . , Kin: Kin represents the total number of input channels and n represents the time) of a plurality of input channels and extracts a component Mi(n) included commonly in the plural input channels.

The non-common component extraction unit 220 inputs the signals In(n, k) of the plural input channels and extracts a component Si(n) not common to the plural input channels.

The common component noise suppression unit 320 obtains signal Mo(n) by executing a noise suppression process for the component Mi(n) extracted by the common component extraction unit 120, and then outputs the signal Mo(n). In addition, the common component noise suppression unit 320 detects the level of the noise signal included in the component Mi(n), i.e. the noise signal level of the common component and notifies the non-common component processing unit 420 of the detected noise signal level.

The non-common component processing unit 420 obtains signal So(n) by executing a predetermined level adjustment process (for example, attenuation or emphasis) for the component Si(n) extracted by the non-common component extraction unit 220, at a intensity corresponding to the level notified by the common component noise suppression unit 320, and then outputs the signal So(n).

It is considered that a noise signal included in a component common to a plurality of input channels and a noise signal included in a non-common component are correlated to some extent. The noise suppressing apparatus of the second embodiment focuses on this matter. For example, by considering that when the noise in the component common to a plurality of input channels is great the noise in the non-common component is also great, the suppression at the non-common component processing unit 420 is made slightly strong. Oppositely, if non-common component processing unit 420 may detect the noise level of the non-common component, and the gain G in the common component noise suppression unit 320 may be made smaller by considering that when the noise in the non-common component is great the noise of the common component is also great.

The plural-channel generation unit 520 removes noise of the common component in the signals In(n, k) of the plural input channels, by using the signal Mo(n) obtained by the common component noise suppression unit 320 and the signal So(n) obtained by the non-common component processing unit 420, and outputs each of output signals Out(n, k) (k=1, . . . , Kout: Kout represents the total number of output channels, and n represents the time) in which the non-common component is attenuated or emphasized.

Each of the total number of input channels Kin and the total number of output channels Kout may preferably be equal to or greater than 2. To simplify the following descriptions, the case of Kin and Kout being equal to 2, i.e. the stereo input and the stereo output is explained. In this case, for example, the noise suppressing apparatus shown in FIG. 3 may be constituted as shown in FIG. 4.

A common component extraction unit 121 inputs signals In(n, 1) and In(n, 2) of two input channels, and extracts component Mi(n) included commonly in the two input channels, by the operation represented above in the formula (1). For example, the component is extracted by an operation represented by the following formula (1). In other words, by executing addition of the signals In(n, 1) and In(n, 2) of the two input channels, the component of the common phase obtains a signal which becomes more remarkable.

A non-common component extraction unit 221 inputs the signals In(n, 1) and In(n, 2) of two input channels and extracts component Si(n) not common to the two input channels. For example, the component is extracted by an operation represented above in the formula (2). In other words, by executing subtraction of the signals In(n, 1) and In(n, 2) of the two input channels, the component not common in phase obtains a signal which becomes more remarkable.

A monaural component noise suppression unit 321 obtains signal Mo(n) by executing a noise suppression process for the component Mi(n) extracted by the common component extraction unit 121, and then output the signal Mo(n). As the method of noise suppressing process, the same method as that of the monaural component noise suppression unit 311 is considered.

In addition, the monaural component noise suppression unit 321 detects the level of the noise signal included in the component Mi(n), i.e. the noise signal level of the monaural component, and notifies the stereo component processing unit 421 of the detected noise signal level.

In the stereo component processing unit 421, a predetermined level adjustment process (for example, attenuation or emphasis) is executed for the component Si(n) extracted by the non-common component extraction unit 221, at the intensity corresponding to the level notified by the monaural component noise suppression unit 321, and signal So(n) is obtained and output. In the case of attenuation, an operation is executed in the above-described formula (3) using gain G. As a concrete manner of determining the gain G, for example, G=α×MiSNR may be calculated by using the SNR (signal-to-noise ratio) of the component Mi(n), where α represents a constant and MiSNR represents the SNR of the component Mi(n). Furthermore, the gain for noise suppression may be calculated from the SNR (“a priori SNR” disclosed in the above-explained documents of the MMSE-STSA) of the component Mi(n), in the spectral subtraction, MMSE-STSA and Wiener filter disclosed in the above-explained documents, and this gain may be used as the gain G.

In addition, the noise level of the non-common component may be detected by the stereo component processing unit 421 and, if the noise is great, the gain G at the common component noise suppression unit 320 may be made smaller while discriminating that the noise of the common component is also great. For example, G may be N_c×(p-th power of N_si) where N_Si represents the noise level of the component Si(n), and p and N_c are constants; for example, p=−1, N_{—c=-16} [dB]. However, G is limited to the value in a range from 0 to 1.

The plural-channel generation unit 521 comprises a channel generation unit 521a and a channel generation unit 521b. Each of the channel generation unit 521a and the channel generation unit 521b removes the noise of the common component from the signals In(n, 1) and In(n, 2) of the two input channels and outputs output signals Out(n, 1) and Out(n, 2) obtained by attenuating or emphasizing the non-common component, by using the signal Mo(n) obtained by the monaural component noise suppression unit 321 and the signal So(n) obtained by the stereo component processing unit 421. For example, the output signals are obtained in the above formula (4) and formula (5) and then output.

To make the amplitudes of the signals In(n, 1) and In(n, 2) of the two input channels match the amplitude of each of the output signals Out(n, 1) and Out(n, 2), Out_new(n, 1) and Out_new(n, 2) may be output instead of Out(n, 1) and Out(n, 2) by adding operations represented in the above formula (6) and formula (7).

In the noise suppressing apparatus having the above-described configuration, noise of the sound in which the sound image is present in the central direction, of the signals of the two input channels, i.e. stereo signals, is suppressed and, for example, an effect of making voice of an announcer commentating in a live sport program or the like easily heard can be obtained. In addition, the stereo component can be attenuated or emphasized irrespective of the monaural component. For this reason, if the stereo component is subjected to gain adjustment such as adjusting the sound volume, the sound can be heard with a natural sound image.

In addition, since the noise suppression and the gain adjustment in the common component and the non-common component are executed on the basis of the correlation between the common component and the non-common component, the noise in the common component can be suppressed more naturally, the sound image in the non-common component can be maintained more naturally, and the effect of making the sound easily heard can be obtained. For example, in the two-channel inputting, the effect of making an announcer commentating in a live sport program easily heard can be obtained.

Next, a noise suppressing apparatus according to a third embodiment of the present invention will be described.

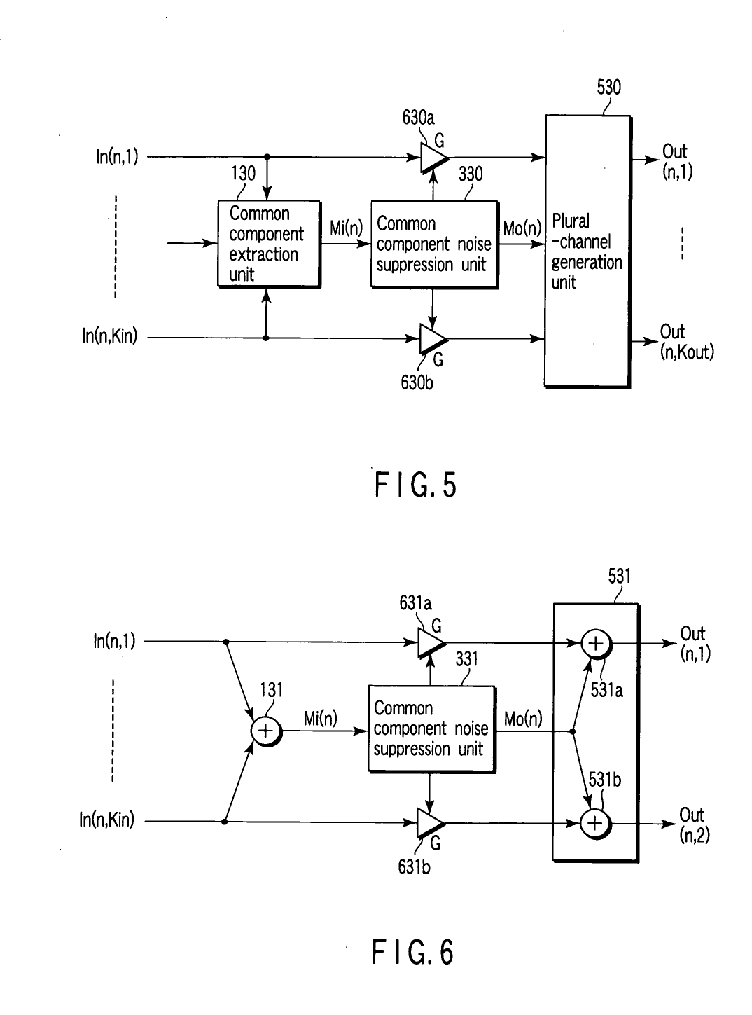

FIG. 5 shows a configuration of the noise suppressing apparatus according to the third embodiment. The noise suppressing apparatus comprises a common component extraction unit 130, a common component noise suppression unit 330, a plural-channel generation unit 530, and gain adjustment units 630a, 630b.

The common component extraction unit 130 inputs signals In(n, k) (k=1, . . . , Kin: Kin represents the total number of input channels and n represents the time) of a plurality of input channels and extracts a component Mi(n) included commonly in the plural input channels.

The common component noise suppression unit 330 obtains signal Mo(n) by executing a noise suppression process for the component Mi(n) extracted by the common component extraction unit 130, and then outputs the signal Mo(n). In addition, the common component noise suppression unit 330 detects the level of the noise signal included in the component Mi(n), i.e. the noise signal level of the common component and notifies the gain adjustment units 630a, 630b of the detected noise signal level.

The gain adjustment units 630a and 630b execute the suppression of the signal level using the gain G corresponding to the noise signal level notified by the common component noise suppression unit 330, for signals In(n, k) of the input channels. As for a concrete calculation of the gain G, for example, the method of calculating the gain G as described above in relation to the stereo component processing unit 421 of the second embodiment can be employed.

It is considered that a noise signal included in a component common to a plurality of input channels and a noise signal included in a non-common component are correlated to some extent. The noise suppressing apparatus of the third embodiment focuses on this matter. For example, by considering that the noise in the signal of each input channel is also great if the noise in the component common to a plurality of input channels is great, the suppression at the gain adjustment units 630a, 630b is made slightly strong.

As another constituent feature, the gain adjustment units 630a and 630b may detect the noise level of each input channel, and may make the gain G in the common component noise suppression unit 330 smaller by considering that when the noise level in the input channel is great the noise in the common component is also great. As a concrete manner of determining the gain G, for example, for example, the method described in relation to the stereo component processing unit 421 of the second embodiment can be employed.

The plural-channel generation unit 530 removes the noise of the common component from the signals In(n, k) of the respective input channels, by using the signal Mo(n) obtained by the common component noise suppression unit 330 and the signals obtained by the gain adjustment units 630a, 630b, removes the noise of the non-common component from each of output signals Out(n, k) (k=1, . . . , Kout: Kout represents the total number of output channels, and n represents the time) and outputs the signals.

Each of the total number of input channels Kin and the total number of output channels Kout may preferably be equal to or greater than 2. To simplify the following descriptions, the case of Kin and Kout being equal to 2, i.e. the stereo input and the stereo output is explained. In this case, for example, the noise suppressing apparatus shown in FIG. 5 may be constituted as shown in FIG. 6.

A common component extraction unit 131 inputs signals In(n, 1) and In(n, 2) of two input channels, and extracts component Mi(n) included commonly in the two input channels, by the operation represented above in the formula (1).

A monaural component noise suppression unit 331 obtains signal Mo(n) by executing a noise suppression process for the component Mi(n) extracted by the common component extraction unit 131, and then outputs the signal Mo(n). As the method of noise suppressing process, the same method as that of the monaural component noise suppression unit 311 is considered.

In addition, the monaural component noise suppression unit 331 detects the level of the noise signal included in the component Mi(n), i.e. the noise signal level of the monaural component, and notifies the gain adjustment units 631a, 631b of the detected noise signal level.

The gain adjustment units 631a and 631b execute the suppression of the signal level using the gain G corresponding to the noise signal level notified by the common component noise suppression unit 331, for signals In(n, k) of the input channels.

As another constituent feature, the gain adjustment units 631a and 631b may detect the noise levels of signals of the respective input channels, and may make the gain G in the common component noise suppression unit 331 smaller by considering that when the noise level is great the noise of the common component is also great.

The plural-channel generation unit 531 comprises a channel generation unit 531a and a channel generation unit 531b. The channel generation unit 531a obtains the output signal Out(n, 1) obtained by removing the noise of the common component from the signal In(n, 1) of the input channel, by using the signal Mo(n) obtained by the common component noise suppression unit 331 and the signal obtained by the gain adjustment unit 631a, and outputs the obtained output signal. Similarly, the channel generation unit 531b obtains the output signal Out(n, 2) obtained by removing the noise of the non-common component from the signal In(n, 2) of the input channel, by using the signal Mo(n) obtained by the common component noise suppression unit 331 and the signal obtained by the gain adjustment unit 631b, and outputs the obtained output signal.

To make the amplitudes of the signals In(n, 1) and In(n, 2) of the two input channels match the amplitude of each of the output signals Out(n, 1) and Out(n, 2), Out_new(n, 1) and Out_new(n, 2) may be output instead of Out(n, 1) and Out(n, 2) by adding operations represented in the above formula (6) and formula (7).

In the noise suppressing apparatus having the above-described configuration, noise of the sound in which the sound image is present in the central direction, of the signals of the two input channels, i.e. stereo signals, is suppressed and, for example, an effect of making voice of an announcer commentating in a live sport program or the like easily heard can be obtained.

In addition, since the noise suppression and the gain adjustment in the common component and the signal of each input channel are executed on the basis of the correlation between the common component and the signal of the input channel, the noise in the common component can be suppressed more naturally, the sound image in the non-common component can be maintained more naturally, and the effect of making the sound easily heard can be obtained. For example, in the two-channel inputting, the effect of making an announcer commentating in a live sport program easily heard can be obtained.

The present invention is not limited to the embodiments described above but the constituent elements of the invention can be modified in various manners without departing from the spirit and scope of the invention. For example, the ideas explained above in the formula (1) to formula (7) can be applied not only to the time domain, but also to the frequency domain. In this case, calculation for each sample can be replaced with calculation for each spectrum or calculation for each frequency domain.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A noise suppressing apparatus, suppressing noise components included in input signals of a plurality of channels, comprising:
a common component extraction unit which extracts a component common to a first channel signal and a second channel signal;
a common component noise suppression unit which suppresses noise in the common component extracted by the common component extraction unit;
a non-common component extraction unit which extracts a component not common to the first channel signal and the second channel signal;
a non-common component processing unit which executes level adjustment of the non-common component extracted by the non-common component extraction unit; and
a plural-channel generation unit which generate the first channel signal and the second channel signal having the noise components suppressed, from an output of the common component noise suppression unit and an output of the non-common component processing unit, respectively.

2. The apparatus according to claim 1, wherein
by adding the first channel signal and the second channel signal, the common component extraction unit extracts a signal in which a component common to both the signals is significant;
by subtracting the first channel signal and the second channel signal, the non-common component extraction unit extracts a signal in which a component not common to both the signals is significant;
the plural-channel generation unit comprises a first channel generation unit and a second channel generation unit;
the first channel generation unit generates the first channel signal having the noise component suppressed, by adding the output of the common component noise suppression unit and the output of the non-common component processing unit; and
the second channel generation unit generates the second channel signal having the noise component suppressed, by subtracting the output of the non-common component processing unit from the output of the common component noise suppression unit.

3. The apparatus according to claim 1, further comprising:
a detection unit which detects a level of noise included in the common component extracted by the common component extraction unit,
wherein the non-common component processing unit executes the level adjustment of the non-common component extracted by the non-common component extraction unit, in accordance with the noise level detected by the detection unit.

4. The apparatus according to claim 3, wherein
by adding the first channel signal and the second channel signal, the common component extraction unit extracts a signal in which a component common to both the signals is significant;
by subtracting the first channel signal and the second channel signal, the non-common component extraction unit extracts a signal in which a component not common to both the signals is significant;
the plural-channel generation unit comprises a first channel generation unit and a second channel generation unit;
the first channel generation unit generates the first channel signal having the noise component suppressed, by adding the output of the common component noise suppression unit and the output of the non-common component processing unit; and
the second channel generation unit generates the second channel signal having the noise component suppressed, by subtracting the output of the non-common component noise suppression unit from the output of the common component processing unit.

5. The noise suppressing apparatus according to claim 1, further comprising:
a detection unit which detects a level of noise included in the non-common component extracted by the non-common component extraction unit,
wherein the common component noise suppression unit suppresses the noise in the common component extracted by the common component extraction unit, in accordance with the noise level detected by the detection unit.

6. The apparatus according to claim 5, wherein
by adding the first channel signal and the second channel signal, the common component extraction unit extracts a signal in which a component common to both the signals is significant;
by subtracting the first channel signal and the second channel signal, the non-common component extraction unit extracts a signal in which a component not common to both the signals is significant;
the plural-channel generation unit comprises a first channel generation unit and a second channel generation unit;
the first channel generation unit generates the first channel signal having the noise component suppressed, by adding the output of the common component noise suppression unit and the output of the non-common component processing unit; and
the second channel generation unit generates the second channel signal having the noise component suppressed, by subtracting the output of the non-common component processing unit from the output of the common component noise suppression unit.

7. A noise suppressing apparatus suppressing noise components included in input signals of a plurality of channels, comprising:
a common component extraction unit which extracts a component common to a first channel signal and a second channel signal;
a detection unit which detects a level of noise included in the common component extracted by the common component extraction unit;
a common component noise suppression unit which suppresses the noise in the common component extracted by the common component extraction unit;
a first level adjustment unit which executes level adjustment of the first channel signal, in accordance with the noise level detected by the detection unit;
a second level adjustment unit which executes level adjustment of the second channel signal, in accordance with the noise level detected by the detection unit; and
a plural-channel generation unit which generate the first channel signal and the second channel signal having the noise components suppressed, from an output of the common component noise suppression unit, an output of the first level adjustment unit and an output of the second level adjustment unit.

8. A method of suppressing noise components included in input signals of a plurality of channels, comprising:
a first step of extracting a component common to a first channel signal and a second channel signal;
a second step of suppressing noise in the common component extracted in the first step;
a third step of extracting a component not common to the first channel signal and the second channel signal;
a fourth step of executing level adjustment of the non-common component extracted in the third step; and
a fifth step of generating the first channel signal and the second channel signal having the noise components suppressed from an output of the second step and an output of the fourth step, respectively.

9. The method according to claim 8, wherein
by adding the first channel signal and the second channel signal, the first step extracts a signal in which a component common to both the signals is significant;
by subtracting the first channel signal and the second channel signal, the third step extracts a signal in which a component not common to both the signals is significant;
the fifth step comprises a sixth step and a seventh step;
the sixth step generates the first channel signal having the noise component suppressed, by adding the output of the second step and the output of the fourth step; and
the seventh step generates the second channel signal having the noise component suppressed, by subtracting the output of the fourth step from the output of the second step.

10. The method according to claim 8, further comprising:
a detection step of detecting a level of noise included in the common component extracted in the first step,
wherein the fourth step executes the level adjustment of the non-common component extracted in the third step, in accordance with the noise level detected in the detection step.

11. The method according to claim 10, wherein
by adding the first channel signal and the second channel signal, the first step extracts a signal in which a component common to both the signals is significant;
by subtracting the first channel signal and the second channel signal, the third step extracts a signal in which a component not common to both the signals is significant;
the fifth step comprises a sixth step and a seventh step;
the sixth step generates the first channel signal having the noise component suppressed, by adding the output of the second step and the output of the fourth step; and
the seventh step generates the second channel signal having the noise component suppressed, by subtracting the output of the fourth step from the output of the second step.

12. The method according to claim 8, further comprising:
a detection step of detecting a level of noise included in the non-common component extracted in the third step,
wherein the second step suppresses the noise in the common component extracted in the first step, in accordance with the noise level detected by the detection step.

13. The method according to claim 12, wherein
by adding the first channel signal and the second channel signal, the first step extracts a signal in which a component common to both the signals is significant;
by subtracting the first channel signal and the second channel signal, the third step extracts a signal in which a component not common to both the signals is significant;
the fifth step comprises a sixth step and a seventh step;
the sixth step generates the first channel signal having the noise component suppressed, by adding the output of the second step and the output of the fourth step; and
the seventh step generates the second channel signal having the noise component suppressed, by subtracting the output of the fourth step from the output of the second step.
